(19) United States
(12) Patent Application Publication
(10) Pub. No.: US 2026/0227553 A1
(43) Pub. Date: Aug. 6, 2026

(54) LONG-WAVE INFRARED PHASE MODULATION AND POLARIZATION ELLIPTICITY STANDARD

(71) Applicant: Texas Tech University System, Lubbock, TX (US)

(72) Inventors: Myoung-hwan KIM, Lubbock, TX (US); Zachary BROWN, Lubbock, TX (US); Satya KACHIRAJU, Edinburg, TX (US)

(21) Appl. No.: 19/147,123

(22) PCT Filed: Mar. 3, 2024
(86) PCT No.: PCT/US2024/018275

§ 371 Date: Jul. 10, 2025

Related U.S. Application Data
(60) Provisional application No. 63/449,705, filed on Mar. 3, 2023.

(51) Int. Cl. G02B 5/18; G02B 5/00; G02B 5/30

(52) U.S. Cl. CPC G02B 5/1814; G02B 5/008; G02B 5/1857; G02B 5/1861; G02B 5/3025; G02B 2207/101

(57) ABSTRACT

CSPP devices, methods of fabricating CSPP devices, and systems with CSPP devices are provided. The CSPP devices of this disclosure a polar dielectric substrate, an insulator layer disposed on the polar dielectric substrate. The polar dielectric substrate having a phonon polariton surface contacting the insulator layer. A grating including a plurality of grating structures is disposed on a plasmon polariton surface of the insulator layer such that adjacent grating structures of the plurality of grating structures form gaps therebetween. The insulator layer is exposed in each of the gaps and FP cavities are in the insulator layer under each of the grating structures, the FP cavities having a FP refractive index different than a refractive index of the regions of the insulator layer exposed by the gaps. The CSPP devices allow for phase modulation at longer infrared wavelengths and have a resonance due to the array of FP cavities.

### CROSS-REFERENCE TO RELATED PATENT APPLICATIONS

This application claims priority to U.S. Provisional Patent Application Ser. No. 63/449705, filed on Mar. 3, 2023, which is herein incorporated by reference.

### STATEMENT OF FEDERALLY FUNDED RESEARCH

This disclosure was made with government support under Grant No. 2021BC0121 CINT User Program at Sandia Laboratory (“Reconfigurable Phonon Polaritonic Metasurfaces to Tailor Infrared Light on Surfaces’) awarded by the Department of Energy. The government has certain rights in the disclosure.

### BACKGROUND

### Field

Embodiments of the present disclosure generally relate to phonon polaritonic devices. More particularly, embodiments of the present disclosure relate to phonon polaritonic devices, methods of fabricating phonon polaritonic devices, and systems with phonon polaritonic devices.

### Description of the Related Art

Optical phase modulators are essential components in a range of systems, including optical communication, sensing, and signal processing. In recent years, they have also been used in the field of quantum computing and quantum information science, where they can be employed to control the polarization state of qubits such as electron spin or nuclear spin. Optical phase modulators enable accurate measurement of the polarization state of light, including rotation and ellipticity. While there are standards for measuring the rotation of polarization, such as the geometric angle, there is currently no standard for measuring the ellipticity of polarization, which is described using geometric shapes like circles, lines, and ellipses in a single parameter. These geometric definitions are also used to characterize the polarization state of light. The development of optical phase modulators for use in the long infrared range is desired and there is currently not a standard for measuring polarization ellipticity.

According what is needed in the art are coupled surface plasmon-phonon polariton (CSPP) devices, methods of fabricating CSPP devices, and systems with CSPP devices for longwave infrared phase modulation and measuring polarization ellipticity and rotation.

### SUMMARY

In one embodiment, a coupled surface plasmon-phonon polariton (CSPP) device is provided. The CSPP device includes a polar dielectric substrate, an insulator layer disposed on the polar dielectric substrate, the polar dielectric substrate having a phonon polariton surface contacting the insulator layer, and a grating comprising a plurality of grating structures disposed on a plasmon polariton surface of the insulator layer, adjacent grating structures of the plurality of grating structures forming gaps therebetween, the insulator layer is exposed in each of the gaps, and Fabry-Pérot (FP) cavities in the insulator layer under each of the grating structures. The FP cavities having a FP refractive index different than a refractive index of the regions of the insulator layer exposed by the gaps. The CSPP device is operable to receive incident beams of light, diffract the at least a portion of the incident beams through the gaps to undergo resonance in the FP cavities, and reflect beams, the reflect reflected beams having a linear polarization or an elliptical polarization.

In another embodiment, a method is provided. The method includes disposing an insulator layer on a polar dielectric substrate, disposing a resist on the insulator layer disposed on the polar dielectric substrate, the polar dielectric substrate having a phonon polariton surface contacting the insulator layer, patterning the resist to form an inverse pattern of a grating, depositing a metal-containing material of the grating in spaces of the inverse pattern of the resist, and removing the resist to form the grating comprising a plurality of grating structures on a plasmon polariton surface of the insulator layer, adjacent grating structures of the plurality of grating structures forming gaps therebetween, the insulator layer is exposed in each of the gaps. Fabry-Pérot (FP) cavities are disposed in the insulator layer under each of the grating structures.

In yet another embodiment, a system is provide. The system includes a light source, a first polarizer, a coupled surface plasmon-phonon polariton (CSPP) device, a second polarizer, and a detector. The CSPP device includes a polar dielectric substrate, an insulator layer disposed on the polar dielectric substrate, the polar dielectric substrate having a phonon polariton surface contacting the insulator layer, and a grating comprising a plurality of grating structures disposed on a plasmon polariton surface of the insulator layer, adjacent grating structures of the plurality of grating structures forming gaps therebetween, the insulator layer is exposed in each of the gaps, and Fabry-Pérot (FP) cavities disposed in the insulator layer under each of the grating structures, the FP cavities having a FP refractive index different than a refractive index of the regions of the insulator layer exposed by the gaps.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1A is a schematic, perspective view of a coupled surface plasmon-phonon polariton (CSPP device according to embodiments described herein.

FIG. 1B is a schematic, cross-sectional view of a CSPP device according to embodiments described herein.

FIG. 1C is a schematic, top view of a CSPP device according to embodiments described herein.

FIG. 1D is a schematic, perspective view of a CSPP device in operation according to embodiments described herein.

FIG. 1E is a graph of the measured reflection spectra of a CSPP device according to embodiments described herein.

FIGS. 2A-2E are schematic, cross-sectional views of a substrate during a method of forming a CSPP according to embodiments described herein.

FIG. 3A is a schematic diagram of a system in a calibration mode according to embodiments described herein.

FIG. 3B is a graph of a polarization rotation spectrum of a CSPP device according to embodiments described herein.

FIG. 3C is a graph of an ellipticity spectrum of a CSPP device according to embodiments described herein.

FIGS. 4A and 4B are schematic diagrams of a system in a measurement mode according to embodiments described herein.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments of the present disclosure generally relate to phonon polaritonic devices. More particularly, embodiments of the present disclosure relate to coupled surface plasmon-phonon polariton (CSPP) devices, methods of fabricating CSPP devices, and systems with CSPP devices. The CSPP devices described herein are operable with long wave infrared wavelengths of 8 microns μ) to 50 μm to modulate its polarization rotation and ellipticity. The CSPP devices of this disclosure utilize metamaterials, and, in some embodiments, an active material platform of insulator-to-metal transition material. The CSPP devices described herein allow for phase (or polarization) modulation at long wave infrared wavelengths via the utilization of Fabry-Pérot cavities. The CSPP devices have a resonance due to the Fabry-Pérot cavity array of coupled surface plasmon-phonon polaritons. When on resonance, light parallel to the grating is reflected, while perpendicular light is absorbed. Off resonance, the reflected light gains additional phase and intensity from the cavity, resulting in changes to its polarization in terms of rotation and ellipticity.

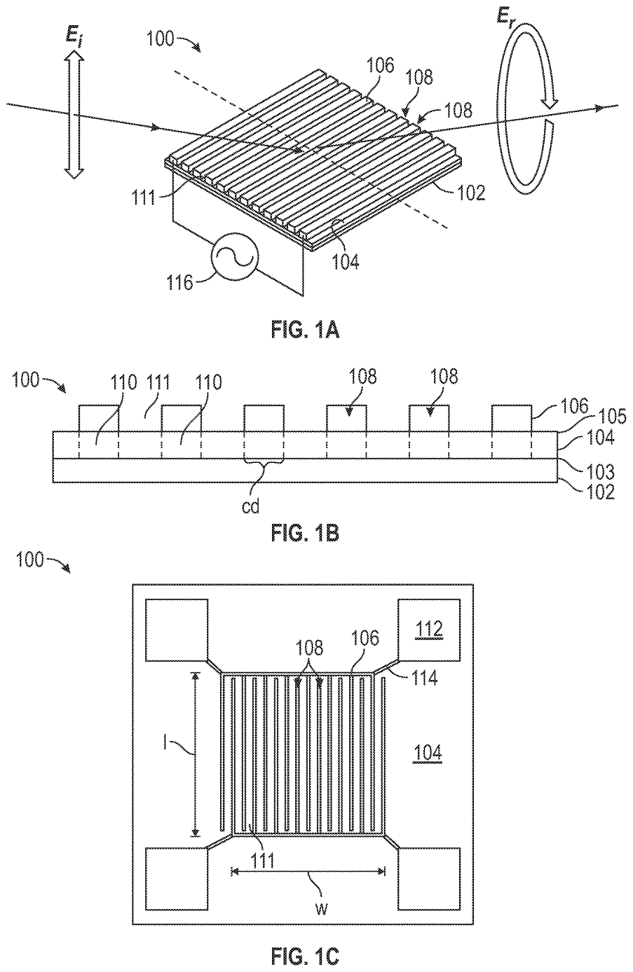

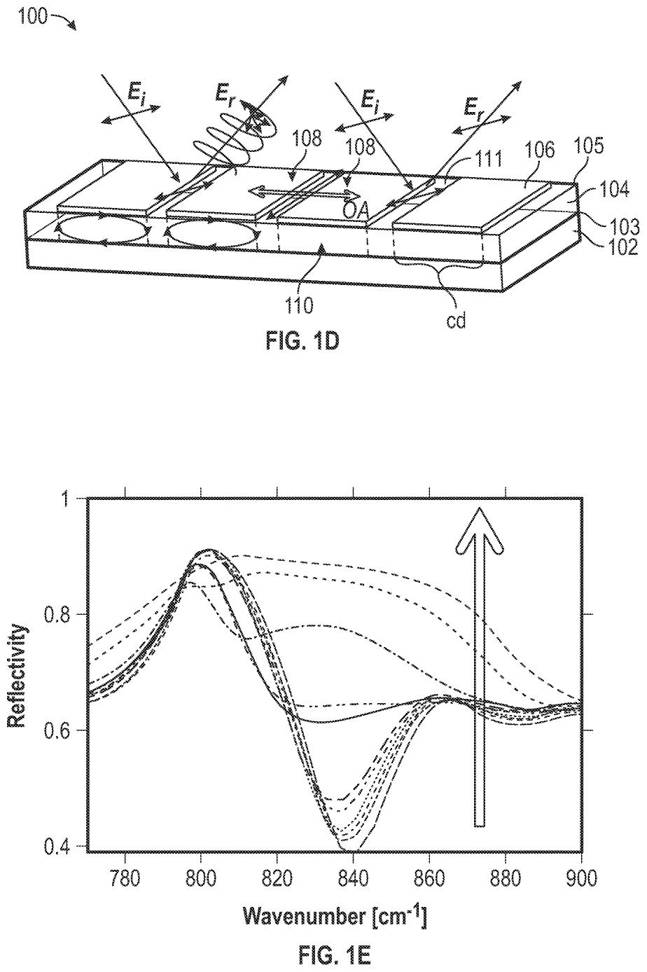

FIG. 1A is a schematic, perspective view of a coupled surface plasmon-phonon polariton (CSPP) device 100. FIG. 1B is a schematic, cross-sectional view of the CSPP device 100. FIG. 1C is a schematic, top view of the CSPP device 100. FIG. 1D is a schematic, perspective view of the CSPP device 100 in operation. As shown in FIGS. 1A, 1B, and 1D, the CSPP device 100 includes a polar dielectric substrate 102 having a phonon polariton surface 103. The polar dielectric substrate 102 includes polar dielectric (also known as ionic crystal) material. The polar dielectric material includes, but is not limited to, silicon carbide (SIC), gallium arsenide (GaAs), sapphire (Al₂O₃), hexagonal boron nitride (h-BN), wurtzite phase aluminum nitride (w-AlN), wurtzite phase gallium nitride w-GaN, gallium phosphide (GaP), zinc oxide (ZnO), aluminum arsenide (AIAs), indium phosphide (InP), indium arsenide (InAs), barium fluoride (BaF₂), indium antimonide (InSb), or combinations thereof. The polar dielectric substrate 102 has a metallic property within its Reststrahlen band. The Reststrahlen band is bounded from transverse to longitudinal optical phonon frequencies of the polar dielectrics.

As shown in FIGS. 1A, 1B, and 1D, an insulator layer 104 is disposed on the phonon polariton surface 103 of the polar dielectric substrate 102. The insulator layer 104 has a plasmon polariton surface 105. The grating 106 is disposed on the plasmon polariton surface 105 of the insulator layer 104. The grating 106 includes a plurality of grating structures 108. Adjacent grating structures of the plurality of grating structures 108 form gaps 111 therebetween. The plasmon polariton surface 105 of the insulator layer 104 is only under the grating structures 108. The plasmon polariton surface 105 of the insulator layer 104 is not present when exposed to the gaps 111. Fabry-Pérot (FP) cavities are in the insulator layer 104 under each of the grating structures 108. In some embodiments, the FP cavities have a FP refractive index greater than a refractive index of the regions of the insulator layer 104 exposed by the gaps 111. In other embodiments, the FP cavities have a FP refractive index less than the refractive index of the regions of the insulator layer 104 exposed by the gaps 111.

As shown in FIG. 1A, in some embodiments, at least some of the grating structures 108 are electrically connected to a power supply 116. The power supply may be an AC or DC power supply. In other embodiments, all of the grating structures 108 are electrically connected to the power supply 116. The power supply 116 is operable to provide electric current to the grating structures 108. As shown in FIG. 1C, in some embodiments, the CSPP device 100 includes at least one contact pad 112. The CSPP device 100 may include four contact pads 112. The contact pads 112 are connected to grating structures 108. In one embodiment, the contact pads 112 are connected to grating structures 108 by lines 114.

The insulator layer 104 may be an insulator material or an insulator-to-metal transition (IMT) material. The insulator layer 104 includes, but is not limited to, silicon dioxide (SiO₂), vanadium dioxide (VO₂), silicon (Si), aluminum oxide (Al₂O₃), or combinations thereof. The IMT material includes a functional material that transitions from an insulator to a metal. In some embodiments including the insulator layer 104 of VO₂, the insulator layer 104 undergoes the insulator-to-metal transition at about 55° C. to about 70° C. dependent on the composition of the polar dielectric material. In other embodiments, The IMT transition temperature about 0° C. to about 70° C. by doping the IMT material of VO₂. The IMT material of VO₂, in some embodiments, include one or more dopants that include, but are not limited to, niobium (Nb), molybdenum (Mo), tungsten (W), or combinations thereof. The grating 106 includes a metal-containing material. In some embodiments, the grating structures 108, the contact pads 112, and the lines 114 include the same metal-containing material. The metal-containing material of the grating 106 includes, but is not limited to, gold (Au), silver (Ag), nickel (Ni), chromium (Cr), iron (Fe), iron oxides, or combinations thereof. In one embodiment, the polar dielectric substrate 102 includes SIC, the insulator layer 104 includes VO₂, and the grating 106 includes Au.

The insulator layer 104 has a thickness of about 100 nanometers (nm). As show in FIG. 1C, the grating 106 has a length I and a width w. The length l is about 100 μm to about 500 μm. The width w is about 100 μm to about 500 μm. The grating 106 has a surface area (l×w) of about 10,000 μm² to about 250,000 μm². The FP cavities 110 have a critical dimension (cd), as shown in FIGS. 1B and 1D. In embodiments utilizing nanoimprint lithography (NIL) or electron beam (e-beam) lithography in fabrication, the cd of the FP cavities 110 is about 0.1 μm to 1 μm. In embodiments utilizing photolithography in fabrication, the cd of the FP cavities 110 is greater than about 2.5 μm. The cd of the FP cavities 110 is sub-wavelength, i.e., less than the wavelength of light projected to the CSPP device 100. In some embodiments, the light is longwave infrared radiation having a wavelength of 8 μm to 50 μm. The CSPP devices 100, in some embodiments, may be arranged in an array such that a system may include multiple CSPP devices 100.

In operation, as shown in FIGS. 1A and 1D, incident beams of light (Eᵢ) having a liner polarization are projected to the CSPP device 100 at an inclination angle. The inclination angle of the incident beams Eᵢ may be normal to the CSPP device, i.e. 90°, as the angle incident light does not affect the resonance of the FP cavities 110. The incident beams Eᵢ are reflected as reflected beams Eᵣ. In some embodiments, e.g., a CSPP device 100 with an insulator layer 104 of IMT material, a portion of the reflected beams Eᵣ have a liner polarization and another portion of the reflected beams Eᵣ have an elliptical polarization. In other embodiments, all of the reflected beams Eᵣ have an elliptical polarization. The FP cavities 110 have a FP refractive index greater or less than the refractive index of the regions of the insulator layer 104 exposed by the gaps 111. The FP refractive index may be increased by the grating structures 108 being over insulator layer 104. The difference in refractive index between FP cavities 110 and regions of the insulator layer 104 exposed by the gaps 111 creates a soft boundary between FP cavities 110 and the regions of insulator layer 104. Incident beams Eᵢ are diffracted through the gaps 111 into the FP cavities 110 to undergo resonance inside the FP cavities 110.

The change in polarization of the reflected beams Eᵣ is a result of at least one of the change in IMT temperature. CSPP devices 100 including the IMT material are active such that the polarization of reflected beams Eᵣ are elliptical based on the temperature of the insulator layer 104 with the IMT material. As the temperature of the insulator layer 104 increases the incident beams Eᵢ undergo resonance in the FP cavities 110. Above the IMT temperature the incident beams Eᵢ are reflected. The temperature of the insulator layer 104 may be controlled by the application of voltage to the CSPP device 100. CSPP device 100 without the IMT material that statically change the polarization are passive and do not modulate.

Each FP cavity 110 forms a standing wave of the coupled surface plasmon-phonon polariton mode perpendicular to the grating axis, which is defined as an optical axis (OA). The resonance frequency in each of the FP cavities 110 depends on the dimensions of the FP cavities 110 and the refractive index of the insulator layer 104. The resonance frequency along the OA is strong, absorbing about 50% to 90% of incident beams Eᵢ at room temperature. In contrast, all light is reflected perpendicular to the OA. A minor plasmonic loss (approximately 10%) of reflected light is observed along the grating 106 (perpendicular to the OA) since the incident electric field drives conduction electrons on the metal-containing material. With the OA aligned along the x-axis and the grating 106 along the y-axis, when illuminating the incident beam Eᵢ with polarization along the x-axis, the incident beam Eᵢ couples strongly with the cavity mode, leading to partial absorption. An incident beam EEᵢ polarized parallel to the y-axis mostly reflects as a reflected beam Eᵣ with a phase shift of TT. For an incident beam Eᵢ light polarized at the projection angle α, e.g., 45° from the y-axis, the polarization can be decomposed into components along the x-axis and the y-axis, i.e., an elliptical polarization. In some embodiments, while the polarization along the y-axis is entirely reflected, the polarization along the x-axis may be only half reflected (and the other half is absorbed). This ratio in active CSPP devices 100 is controlled via change in temperature of the IMT material of the insulator layer 104. The total amplitude of the light's polarization rotates from 45° toward the y-axis and is located between 45°and 90° from the x-axis.

FIG. 1E is a graph of the measured reflection spectra of the CSPP device 100. The reflection spectra is measured along the OA at different temperatures increasing from 25° C. to above the IMT temperature of 55° C. In embodiments including an insulator layer 104 of IMT material, at room temperature, or temperatures, less than the device temperature, the insulating nature of the IMT material within the CSPP device 100 enables light to be partly reflected and partly absorbed by cavity resonance and produces phase shift resulting in an elliptical polarization. The optical index of the insulator layer 104 over the IMT temperature increases and behaves like a metal. Over the IMT temperature reflected beams Eᵣ have a linear polarization matched to the linear polarization of the incident beams Eᵢ. As the temperature increases, the reflectance along the x-axis increases. The polarization is close to the initial polarization of 45° and the same as the initial polarization over the IMT temperature. FIG. 1E highlights a distinct resonance in the measured reflectance at 840 cm⁻¹ (11.9 μm). The cavity resonance of the FP cavity 110 experiences a redshift towards longer wavelengths (lower wavenumbers) due to the increasing real refractive index. The corresponding redshift of nearly 25 cm⁻¹ occurs before reaching the IMT temperature. The resonance weakens due to the increasing imaginary refractive index, reducing resonance strength. Above the IMT temperature, the resonance is not present, leading to a highly reflective surface.

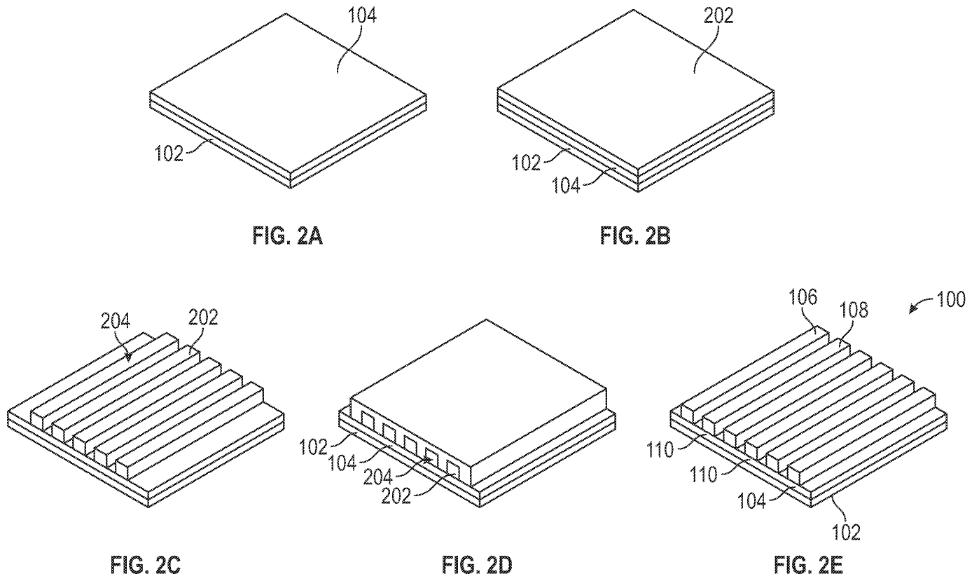

FIGS. 2A-2E are schematic, cross-sectional views of a polar dielectric substrate 102 during a method according of forming a CSPP device 100. In first operation of the method, as shown in FIG. 2A, an insulator layer 104 is disposed over the polar dielectric substrate 102. In a second operation, as shown in FIG. 2B, a resist material 202 is disposed over the insulator layer 104. In a third operation, as shown in FIG. 2C, the resist material 202 is patterned to have an inverse pattern 204 of the grating 106. In a fourth operation, as shown in FIG. 2D, the metal-containing material of the grating 106 is deposited in gaps of the inverse pattern 204. In an optional operation, excess metal-containing material is removed. In a fifth operation, as shown in FIG. 2E, the resist material 202 is removed.

In one embodiment, electron beam lithography is used to pattern the resist material 202. The resist material 202 is an electron beam resist. The electron beam resist includes, but is not limited to, polymethyl methacrylate, In the electron beam lithography process, an electron beam is directed toward the polar dielectric substrate 102 to form the inverse pattern 204 of the grating 106. The resist material 202 may be removed via acetone after deposition of metal-containing material of the grating 106. In another embodiment, nanoimprint lithography is used to pattern the resist material 202. The resist material 202 is an imprintable resist. The imprintable resist may be cured by exposure to ultraviolet (UV) light. In the nanoimprint lithography process, a stamp having a positive pattern of the grating 106 is imprinted on the imprintable resist. The imprintable resist is cured to form the inverse pattern 204 of the grating 106 and the stamp is removed. The metal-containing material of the metal-containing material is deposited and the resist is removed.

In yet another embodiment, photolithography is used to pattern the resist material 202. To pattern the resist material a mask includes one or more apertures corresponding to a positive pattern of the grating 106 when the resist is a positive resist. To pattern the resist material the mask includes one or more apertures corresponding to an inverse pattern 204 of the grating 106. A beam is projected by a light source through the one or more apertures with the inverse pattern 204 to the resist material 202. The resist material 202 is developed with the inverse pattern 204.

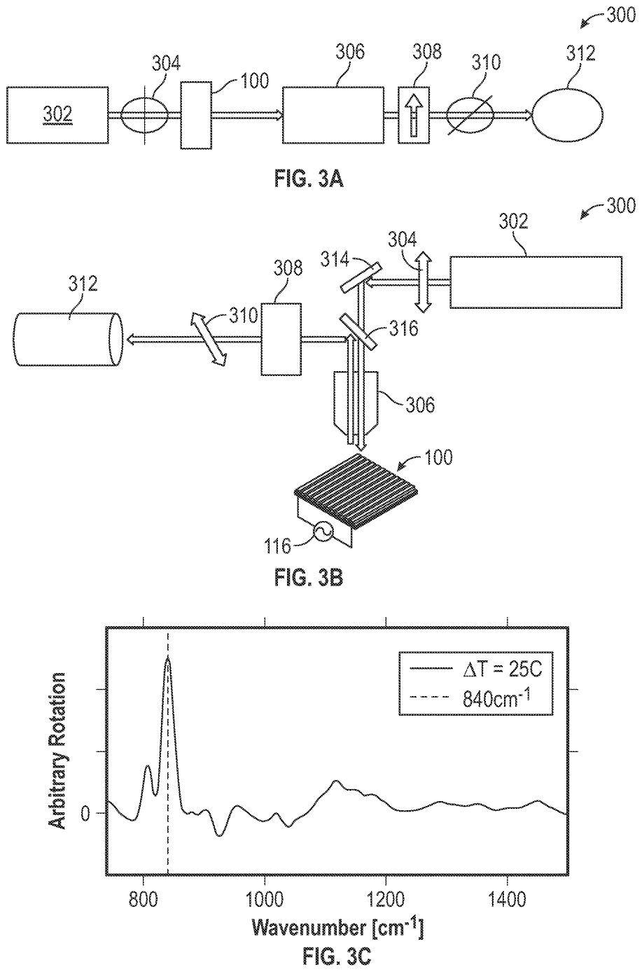

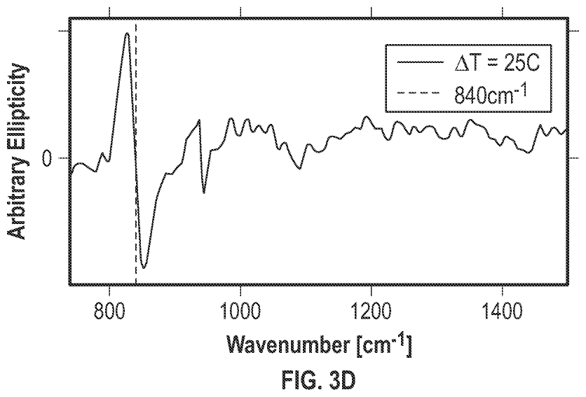

FIG. 3A is a schematic diagram of a system 300 in a calibration mode. The system 300 is a broadband polarimetric spectroscopy and microscopy system used to measure the polarization changes of the CSPP device 100 as a function of wavelength and temperature to calibrate the CSPP device 100 to be utilized for measurement of samples. FIG. 3B is a graph of a polarization rotation spectrum of the CSPP device 100. FIG. 3C is a graph of an ellipticity spectrum of the CSPP device 100. The system 300 includes a low frequency modulation by a Fourier Transform Infrared Spectrometer (FTIR) Spectrometer 302, a first polarizer 304, the CSPP device 100, an objective 306, a photoelastic modulator (PEM) 308, a second polarizer 310, and a detector 312. The detector 312 may be an infrared (IR) detector. The IR detector may be a mercury-cadmium-telluride (MCT) detector. In optional embodiments, the system 300 includes a mirror 314 and a beam splitter 316. The objective 306 may be a microscope. In operation of the system 300, the FTIR spectrometer 302 carries infrared spectrum information while the PEM 308 carries polarization information to the detector 312. The signal from the detector 312 is decoded by a lock-in amplifier and the FTIR spectrometer 302. The beam is projected by the FTIR spectrometer 302 is linearly polarized by the first polarizer 304, is reflected by the mirror 314 and travels to the objective 306 to the CSPP device 100. The polarization of the reflected beam changes when voltage is applied to the CSPP device 100. The reflected beam from the CSPP device 100 to PEM 308. The reflected beam then travels to the second polarizer 310 and the detector 312. The measured rotation, as shown in FIG. 3B, and measured ellipticity is used for measurements of samples.

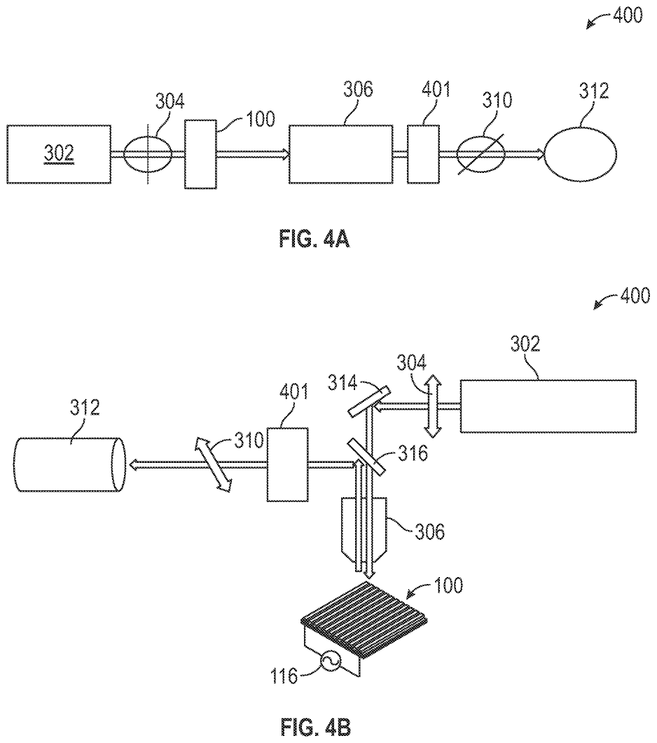

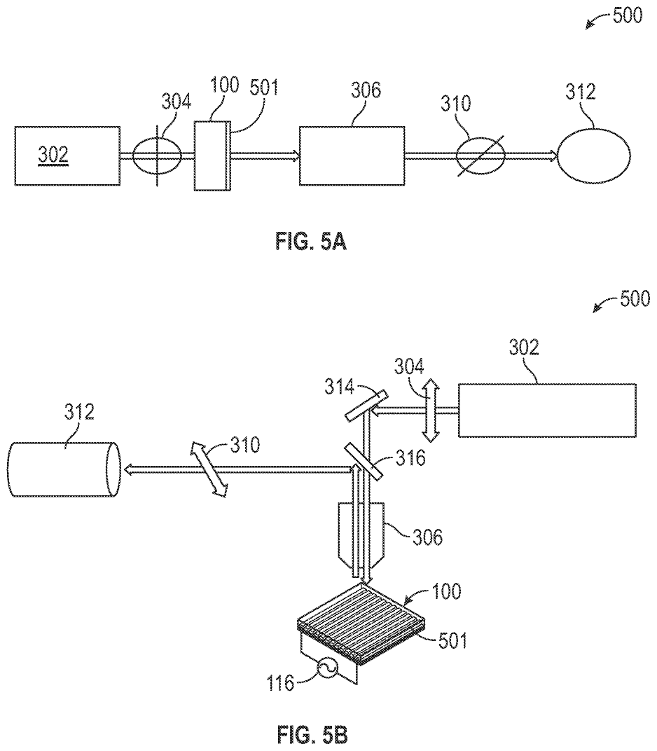

FIG. 4A is a schematic diagram of the system 300 in a first configuration of a measurement mode. In the first configuration of a measurement mode, a sample 401 to be measures replaces the PEM 308. FIG. 4B is a schematic diagram of the system 300 in a second configuration of a measurement mode where the sample 401 is placed on the CSPP device 100. The change in rotation and measured ellipticity all the CSPP devices 100 to be used as detectors. The CSPP devices 100 described herein may be utilized as a chemical detector. The chemical detector has a small microscopic footprint corresponding to the surface area of the grating 106. The grating 106 (array of FP cavities 110) is configurable to be used as a camera or to detect mid and/or FIR wavelengths to detect chemicals. The chemicals include CO, CO₂, H₂S, HCN, or the like. The CSPP devices 100 may be used in first responding, forensics, paramedics, military situations, HAZMAT, anesthesiology, oil and gas, policing, or other fields. For example, a CSPP device 100 may be used as a CO₂ monitor, fingerprint detection, blood detection, substance (e.g., fentanyl) detection, or the like.

The CSPP devices 100 described herein modulate a polarization of the light thermally. The modulation frequency on the order of kHz is desirable. Higher frequency modulation occurs by modulating the polarization of the light electrically. The IMT of an insulator layer 104 can be modulated electronically by employing a grating 106 and a contact pad 112. In this configuration, the grating 106 serves as a localized heating element capable of modulating the IMT transition on the order of kHz or higher modulation frequencies. The CSPP devices 100 described herein are only sensitive to light near the resonant wavelength, which can be designed. In contrast, all other wavelengths are reflected with little to no change in polarization. Therefore, no calibration is needed for the device to get the desired modulation of the operating wavelength. The CSPP devices 100 described herein may be utilized as a reflection-based, narrowband, chip-integrated polarization modulator. The CSPP devices 100 could be configured into arrays with specialized architectures to perform various roles in polarimetry, ellipsometry, and imaging for applications where instrument size, ruggedness, and wavelength selectivity are prohibited.

CSPP devices 100, methods of fabricating CSPP devices 100, and systems 300 with CSPP devices 100 are provided. The CSPP devices 100 of this disclosure utilize metamaterials (i.e., gratings 106) and, in some embodiments, an active material platform of insulator-to-metal transition material (i.e. insulator layer 104 of IMT material). The CSPP devices 100 described herein allow for phase modulation at longer infrared wavelengths via the utilization of FP cavities 110. The CSPP devices 100 have a resonance due to the array of FP cavities 110. When on resonance, light parallel to the grating 106 is reflected, while perpendicular light is absorbed. Off resonance, the reflected light gains additional scattering phase and intensity from each FP cavity 110, resulting in changes to its polarization in terms of rotation and ellipticity.

While the foregoing is directed to embodiments of the present disclosure, other and further embodiments of the disclosure may be devised without departing from the basic scope thereof, and the scope thereof is determined by the claims that follow.

1. A device, comprising:
a polar dielectric substrate;
an insulator layer disposed on the polar dielectric substrate, the polar dielectric substrate having a phonon polariton surface contacting the insulator layer; and
a grating comprising a plurality of grating structures disposed on a plasmon polariton surface of the insulator layer, adjacent grating structures of the plurality of grating structures forming gaps therebetween, the insulator layer is exposed in each of the gaps.

2. The device of claim 1, wherein the insulator layer includes an insulator-to-metal transition (IMT) material.

3. The device of claim 2, wherein the insulator layer functions as an insulator below an IMT temperature and functions as a metal above the IMT temperature.

4. The device of claim 3, wherein the IMT material includes vanadium dioxide (VO₂).

5. The device of claim 1, wherein a power supply is electrically connected to the device.

6. The device of claim 5, wherein the power supply is coupled to at least one contact pad of the device.

7. The device of claim 1, further comprising at least one contact pad.

8. The device of claim 1, wherein the device comprises silicon dioxide (SiO₂), vanadium dioxide (VO₂), silicon (Si), aluminum oxide (Al₂O₃), silicon carbide (SiC), gallium arsenide (GaAs), sapphire (Al₂O3), hexagonal boron nitride (h-BN), wurtzite phase aluminum nitride (w-AlN), wurtzite phase gallium nitride w-GaN, gallium phosphide (GaP), zinc oxide (ZnO), aluminum arsenide (AIAs), indium phosphide (InP), indium arsenide (InAs), barium fluoride (BaF₂), indium antimonide (InSb), or combinations thereof.

9. The device of claim 1, wherein the polar dielectric substrate includes a polar dielectric material.

10. The device of claim 1, wherein the grating includes gold (Au), silver (Ag), nickel (Ni), chromium (Cr), iron (Fe), iron oxides, or combinations thereof.

11. A method, comprising:
disposing an insulator layer on a polar dielectric substrate;
disposing a resist on the insulator layer disposed on the polar dielectric substrate, the polar dielectric substrate having a phonon polariton surface contacting the insulator layer;
patterning the resist to form an inverse pattern of a grating;
depositing a metal-containing material of the grating in spaces of the inverse pattern of the resist; and
removing the resist to form the grating comprising a plurality of grating structures on a plasmon polariton surface of the insulator layer, adjacent grating structures of the plurality of grating structures forming gaps therebetween, the insulator layer is exposed in each of the gaps.

12. The method of claim 11, wherein the resist is patterned via a photolithography process comprising projecting a beam with a light source, the beam is projected through one or more apertures of a mask, the resist is developed with the inverse pattern.

13. The method of claim 12, wherein the one or more apertures of the mask correspond to the inverse pattern of the grating.

14. The method of claim 11, wherein the resist is an electron beam resist and the resist is patterned via an electron beam lithography process comprising directing an electron beam is directed toward the polar dielectric substrate to form the inverse pattern of the grating.

15. The method of claim 11, wherein the resist is an imprintable resist and the resist is patterned via a nanoimprint lithography comprising imprinting a stamp in the imprintable resist and curing the imprintable resist to form the inverse pattern.

16. A system, comprising:
an an array of devices, each device comprising:
a polar dielectric substrate;
an insulator layer disposed on the polar dielectric substrate, the polar dielectric substrate having a phonon polariton surface contacting the insulator layer; and
a grating comprising a plurality of grating structures disposed on a plasmon polariton surface of the insulator layer, adjacent grating structures of the plurality of grating structures forming gaps.

17. (canceled)

18. (canceled)

19. The system of claim 16, wherein:
Fabry-Pérot (FP) cavities are formed in the insulator layer under each of the grating structures, the FP cavities having a FP refractive index different than the refractive index of regions of the insulator layer exposed by the gaps, each device is operable to:
receive incident beams of light;
diffract the at least a portion of the incident beams through the gaps to undergo resonance in the FP cavities; and
reflect beams, the reflected beams having a linear polarization or an elliptical polarization.

20. The system of claim 16, wherein the system is used as a chemical detector via application of a sample on the system.

21. The device of claim 1, wherein:
Fabry-Pérot (FP) cavities are formed in the insulator layer under each of the grating structures, the FP cavities having a FP refractive index different than a refractive index of regions of the insulator layer exposed by the gaps, wherein the device is operable to:
receive incident beams of light;
diffract the at least a portion of the incident beams through the gaps to undergo resonance in the FP cavities; and
reflect beams, the reflected beams having a linear polarization or an elliptical polarization.

22. The device of claim 1, wherein at least one of the insulator layer or the polar dielectric substrate includes a silicon-containing material.

23. The method of claim 11, wherein Fabry-Pérot (FP) cavities are disposed in the insulator layer under each of the grating structures.
